(19) United States
(12) Patent Application Publication
(10) Pub. No.: US 2026/0073712 A1
(43) Pub. Date: Mar. 12, 2026

(54) THREE-DIMENSIONAL OBJECT DETECTION USING STATE-SPACE SPATIOTEMPORAL LEARNING AND DYNAMIC QUERIES

(71) Applicant: QUALCOMM Incorporated, San Diego, CA (US)

(72) Inventors: Rajeev YASARLA, San Diego, CA (US); Hong CAI, San Diego, CA (US); Shizhong Steve HAN, San Diego, CA (US); Fatih Murat PORIKLI, San Diego, CA (US)

(21) Appl. No.: 18/882,586

(22) Filed: Sep. 11, 2024

(51) Int. Cl. G06V 20/64; G06V 10/25; G06V 10/26; G06V 10/764; G06V 10/77; G06V 10/776; G06V 10/80; G06V 10/82

(52) U.S. Cl. CPC G06V 20/64; G06V 10/25; G06V 10/26; G06V 10/764; G06V 10/7715; G06V 10/776; G06V 10/806; G06V 10/82

(57) ABSTRACT

Systems and techniques are described herein for adjusting weights of a machine learning (ML) model. For instance, a process can include filtering an obtained set of proposal pillars and set of proposal features associated with the set of proposal pillars to obtain a set of sampling points; sampling features from a set of images based on the set of sampling points; masking random features from the sampled features to generate a masked set of features; generating, using a state space model, a state-space representation of the features based on the masked set of features and a predicted set of features; mixing the state-space representation of the features to generate mixed features; identifying a set of bounding boxes associated with objects in the set of images based on the mixed features for output; and generating classifications for the objects in the set of images based on the mixed features for output.

### FIELD

The present disclosure generally relates to machine learning (ML) models. For example, aspects of the present disclosure are related to systems and techniques for three-dimensional (3D) object detection using state-space spatiotemporal learning and dynamic queries.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, environment modelling/rendering, etc. One example of such a system is a localization system for XR devices and/or Advanced Driver Assistance System (ADAS) for a vehicle. In such systems, sensor data, such as images captured from one or more cameras, may be gathered, transformed, and analyzed to detect objects in the sensor data using Machine learning (ML) models.

Machine learning (ML) models, such as a neural network (NN) may include multiple layers of interconnected nodes (e.g., neurons). Each node may include various parameters, such as weights and/or bias values, that may be applied to the nodes, along with an activation function to determine whether a node may be used (e.g., activated). These parameters and activation functions may be tuned during training of the ML model to perform various tasks, such as feature/object detection, recognition, etc. In some cases, a ML model may include many millions of nodes along with the associated parameters and activation functions. In some cases, ML models capable of performing 3D object detection can be computationally expensive and/or lack temporal modeling.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for 3D object detection is provided. The apparatus includes at least one memory and at least one processor coupled to the at least one memory. The at least one processor is configured to: filter an obtained set of proposal pillars and set of proposal features associated with the set of proposal pillars to obtain a set of sampling points; sample features from a set of images based on the set of sampling points; mask a random set of features from the sampled features to generate a masked set of features; generate, using a state space model, a state-space representation of the features based on the masked set of features and a predicted set of features; mix the state-space representation of the features to generate mixed features; identify a set of bounding boxes associated with objects in the set of images based on the mixed features; generate classifications for the objects in the set of images based on the mixed features; and output the set of bounding boxes and classifications.

As another example, a method for 3D object detection is provided. The method includes: filtering an obtained set of proposal pillars and set of proposal features associated with the set of proposal pillars to obtain a set of sampling points; sampling features from a set of images based on the set of sampling points; masking a random set of features from the sampled features to generate a masked set of features; generating, using a state space model, a state-space representation of the features based on the masked set of features and a predicted set of features; mixing the state-space representation of the features to generate mixed features; identifying a set of bounding boxes associated with objects in the set of images based on the mixed features; generating classifications for the objects in the set of images based on the mixed features; and outputting the set of bounding boxes and classifications.

In another example, non-transitory computer-readable medium having stored thereon instructions is provided. The instructions, when executed by at least one processor, cause the at least one processor to: filter an obtained set of proposal pillars and set of proposal features associated with the set of proposal pillars to obtain a set of sampling points; sample features from a set of images based on the set of sampling points; mask a random set of features from the sampled features to generate a masked set of features; generate, using a state space model, a state-space representation of the features based on the masked set of features and a predicted set of features; mix the state-space representation of the features to generate mixed features; identify a set of bounding boxes associated with objects in the set of images based on the mixed features; generate classifications for the objects in the set of images based on the mixed features; and output the set of bounding boxes and classifications.

As another example, an apparatus for 3D object detection is provided. The apparatus includes: means for filtering an obtained set of proposal pillars and set of proposal features associated with the set of proposal pillars to obtain a set of sampling points; means for sampling features from a set of images based on the set of sampling points; means for masking a random set of features from the sampled features to generate a masked set of features; means for generating, using a state space model, a state-space representation of the features based on the masked set of features and a predicted set of features; mixing the state-space representation of the features to generate mixed features; means for identifying a set of bounding boxes associated with objects in the set of images based on the mixed features; means for generating classifications for the objects in the set of images based on the mixed features; and means for outputting the set of bounding boxes and classifications.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2A illustrates an example of a fully connected neural network;

FIG. 2B illustrates an example of a locally connected neural network;

FIG. 2C illustrates an example of a convolutional neural network (CNN);

FIG. 2D illustrates a detailed example of a deep convolutional network (DCN);

FIG. 3 is a block diagram illustrating an example of a deep convolutional network;

FIG. 4 is a block diagram illustrating a technique for 3D object detection, in accordance with aspects of the present disclosure;

FIG. 5 is a block diagram illustrating an enhanced technique for 3D object detection using state-space spatiotemporal learning and dynamic queries, in accordance with aspects of the present disclosure;

FIG. 6 is a block diagram illustration operations of a dynamic sampling block, in accordance with aspects of the present disclosure;

FIG. 7 is a block diagram illustrating operations of a state-space based prediction engine, in accordance with aspects of the present disclosure;

FIG. 8 is a block diagram illustrating operations of a state-space adaptive mixing block, in accordance with aspects of the present disclosure;

FIG. 9 is a flow diagram illustrating a process for 3D object detection, in accordance with aspects of the present disclosure; and

FIG. 10 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

In some cases, camera-only 3D object detection can be useful for applications such as autonomous driving due to its cost-effectiveness and ease of detecting road elements. While sparse 3D object detection techniques have been attempted, these techniques can involve heavy computational operations, for example, due to oversampling and/or large matrix operations. Thus, ML models capable of performing 3D object detection using sparse sampling efficiently while maintaining accuracy may be useful.

Systems, apparatuses, electronic devices, methods (also referred to as processes), and computer-readable media (collectively referred to herein as “systems and techniques”) are described herein for 3D object detection using state-space spatiotemporal learning and dynamic in Polsinelli Docket No. 094922-820606 queries. For example, a set of proposal pillars and set of proposal features associated with the set of proposal pillars may be obtained. The proposal pillars may represent bounding boxes and the proposal features may represent features within the bounding boxes. The set of proposal pillars may be filtered, for example, based on a set of images obtained at a previous time (i−1). In some cases, the set of proposal pillars may be filtered by performing cross-attention between the set of proposal features and a state-space representation of the features and performing at least one of a merge operation, remove operation, and/or split operation to obtain a set of sampling points.

A set of images may be obtained at a current time i. Features may be extracted from the set of images and features of the set of images may be sampled based on the set of sampling points. The sampled features may be randomly masked. The randomly masked sampled features may be input to a state space model along with a predicted set of features generated based on a previous set of images (e.g., from i−1) to generate a state space representation of the features. The state-space representation may be mixed to generate mixed features. In some cases, the mixing may be performed with the proposal features using channel mixing and point mixing. Bounding boxes and classifications for objects may then be identified based on the mixed features.

In some cases, the state space model may also generate a set of reconstructed features based on the randomly masked sampled features and a predicted set features for a next set of images (e.g., for i+1). The set of reconstructed features may be compared to the sampled features to generate a first loss. The predicted set of features may be compared to sampled features associated with a next set of images to generate a second loss. The first and second loss may be used to train the state space model.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

Various aspects of the present disclosure will be described with respect to the figures.

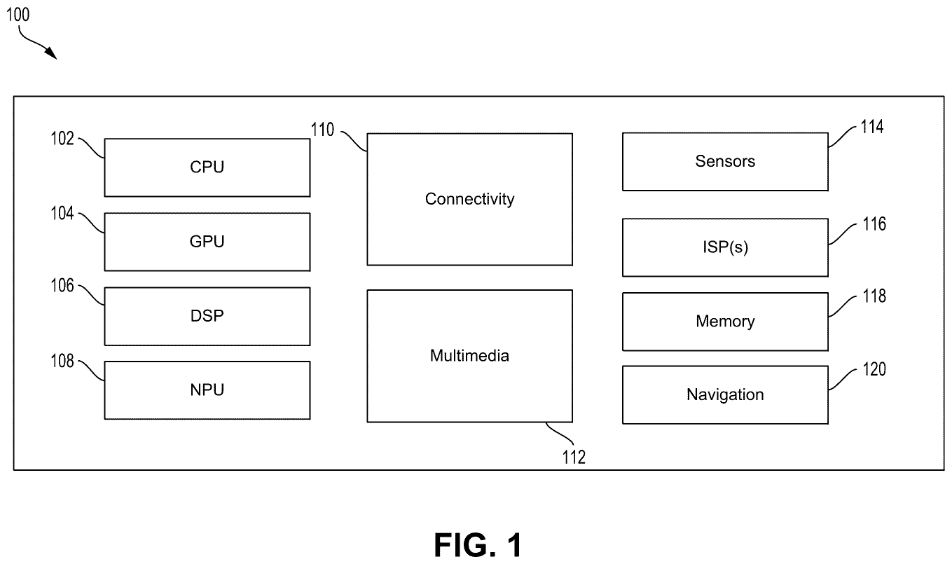

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

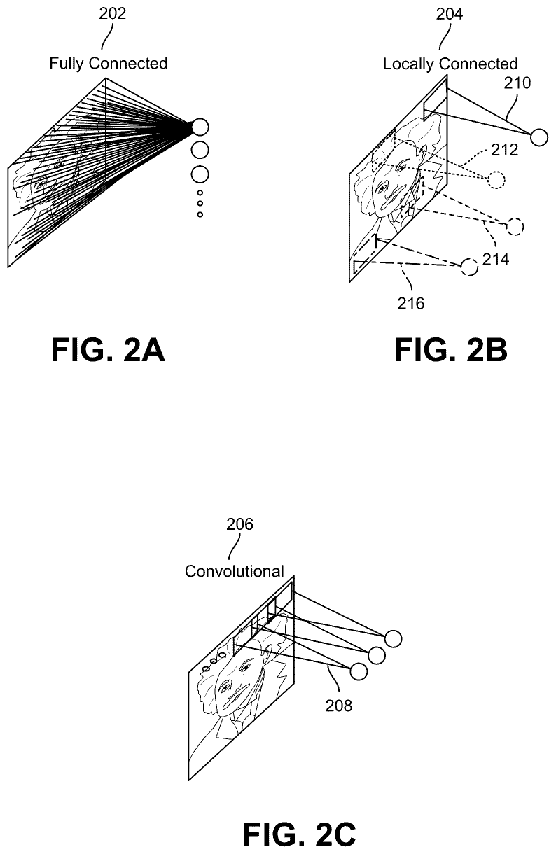

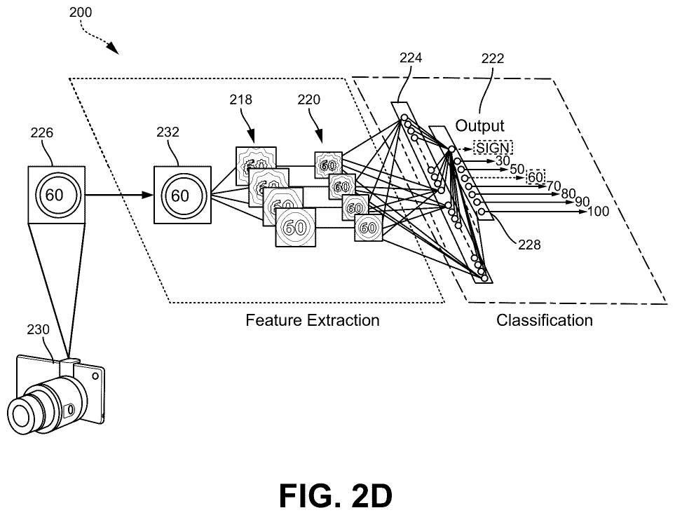

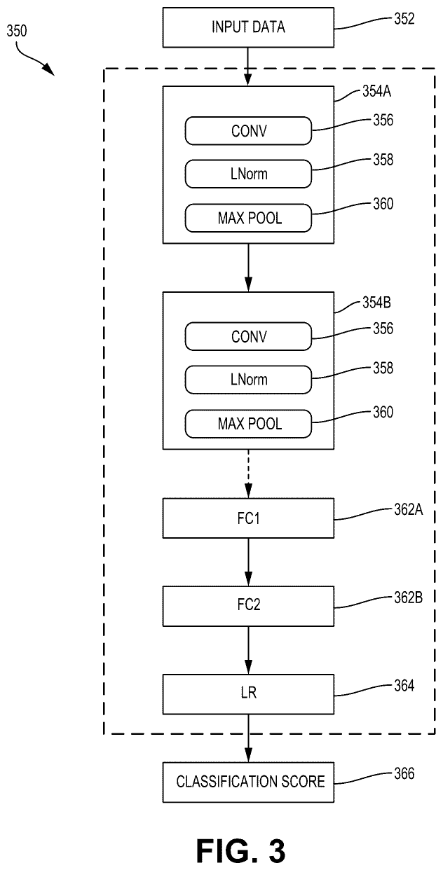

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connect-ed. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decom-pression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A Softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass” through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

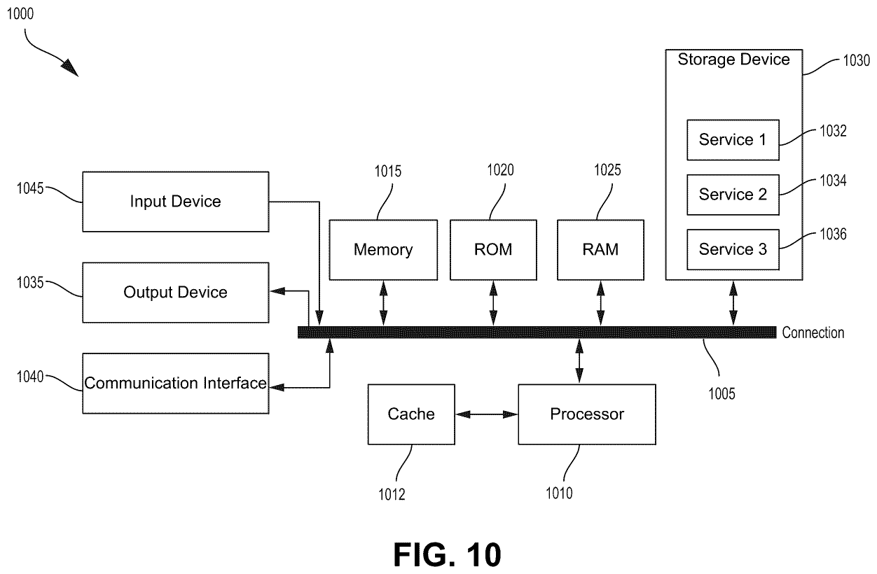

The parallel filter banks, for example, of a deep convolutional network may be loaded on a processor such as a CPU, GPU, NPU, or any other type of processor 1010 discussed with respect to the computing device architecture 1000 of FIG. 10 to achieve high performance and low power consumption. In alternative aspects, the parallel filter banks may be loaded on a DSP or an ISP of the computing device architecture 1000 of FIG. 10. In addition, the deep convolutional network 350 may access other processing blocks that may be present on the computing device architecture 1000 of FIG. 10, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additional ML network components to perform further operations, such as localization, image segmentation, object detection, etc.

In some cases, the extracted features and images may be used to construct a three-dimensional (3D) bird's eye view (BEV) (e.g., a top-down view) multimodal feature map of an environment. For example, an XR device and/or ADAS system may include a suite of sensors that may sense the environment using different techniques. Multimodal features may be generated based on data from multiple different types of sensors, such as an image sensor along with at least one other type of sensor, such as a LIDAR, RADAR, SODAR, SONAR, etc. sensor. Using different sensor types helps provide a more holistic understanding of the environment, increases robustness against failure and/or noise from a single sensor modality, and may help overcome occlusions. In some cases, a sensor type of a sensor may be based on how the sensor senses the environment. For example, two sensors which sense different parts of the electromagnetic spectrum may have different sensor types. Similarly, a sensor which senses reflection/refraction of projected light may have a different sensor type from another sensor which senses natural reflected/refracted light. In some cases, the different sensors may sense the environment in three dimensions. The multimodal features may be transformed into 3D BEV features to help provide a viewpoint invariant representation that encodes semantic information about the environment. Additionally, the 3D BEV features may be normalized based on sensor configuration to help enable generalizability of the multimodal 3D BEV features across systems with different sensors. Based on the 3D BEV features, 3D object detection may be performed to locate and identify objects in the environment. For example, a 3D object detector may place a bounding box around a detected object along with a label identifying the detected object. In some cases, projecting all of the features detected from the sensor information to BEV space to perform object detection may be processing intensive and/or inefficient. In some cases, the detected features may be sparse sampled for projection to 3D BEV space.

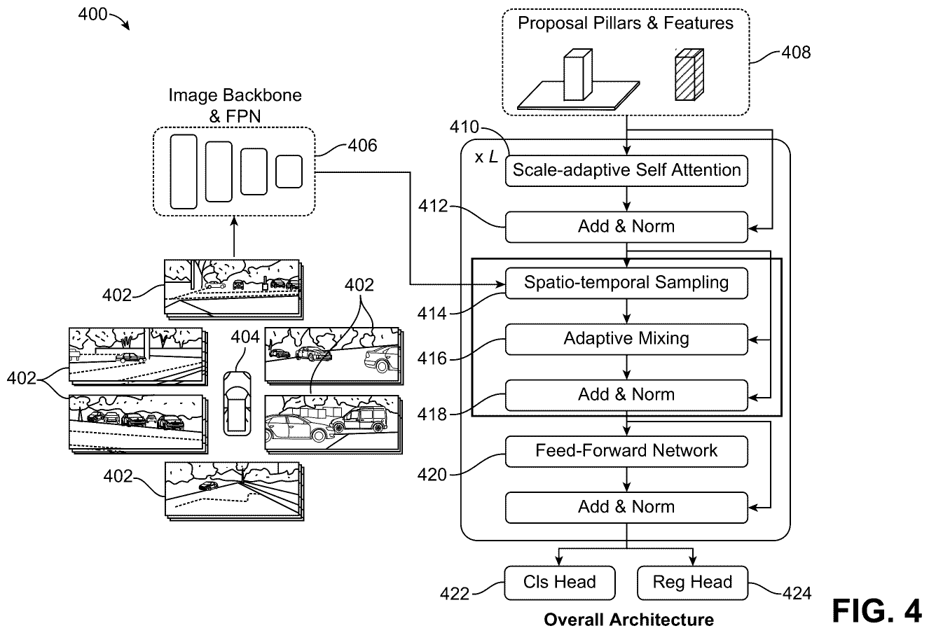

FIG. 4 is a block diagram illustrating a technique for 3D object detection 400, in accordance with aspects of the present disclosure. In FIG. 4, a set of images 402 may be captured by a set of cameras mounted on a vehicle 404. In some cases, the set of images 402 may include images from multiple cameras with different views taken at multiple points in time. For example, in FIG. 4, the set of images 402 may include six view of the environment and each view may include, for example, eight frames captured over a period of time for a total of 48 frames in the set of images 402. The set of images 402 may be input to a feature extraction backbone 406 to detect and extract features (e.g., in an image feature space) from the set of images 402. Examples of the feature extraction backbone may include resnet, pillarnet, etc. In some cases, the features may be extracted using a feature pyramid network. The extracted features may be passed to a spatio-temporal sampling block 414.

A set of sparse pillar queries 408 may be initialized and aggregated using a scale-adaptive self-attention block 410. The sparse pillar queries 408 may be learnable queries and may be initialized as vertical pillars in BEV space. The pillars may represent a bounding box and a pillar may be a vector that includes a 3D location (e.g., x, y, z coordinates) along with a bounding box dimension, orientation of the bounding box, and a 64×1 place feature vector for storing an image feature vector. In some cases, the sparse pillars may be initialized randomly. The scale-adaptive self-attention block 410 may learn appropriate receptive fields based on the queries and features of a previous set of images. The self-attention may consider similarities of features in the pillars in BEV space, as well as the distance between the pillars. As self-attention is applied, over time, queries representing larger objects, such as a bus may have larger receptive field than those representing smaller objects, such as pedestrians. The output of the scale-adaptive self-attention block 410 (e.g., self-attended proposal features) may be summed and normalized 412.

The spatio-temporal sampling block 414 may sample different points from the image feature space based on a set of sparse pillar queries and aggregate the sampled features into an aggregated feature query. The queries may represent bounding box locations in 3D BEV space (e.g., object pillar) and the associated proposal feature represents characteristics of an object in that 3D BEV space. In some cases, a set number of points may be sampled from the image features for each query. As an example, four points may be sampled from the image features for each query. In some cases, a number of queries may also be fixed. For example, the number of queries may be fixed at 900 queries. These samples may be aggregated and passed to an adaptive mixing block 416. The adaptive mixing block 416 may perform channel mixing and point mixing based on weights for the different frames and sampling points. The mixed spatio-temporal features may be flattened, aggregated, and normalized by an add norm block 418. The flattened spatio-temporal features may be passed to a feed-forward network 420, classification head 422, and regression head 424 to generate classification and regression predictions.

As indicated above, there may be 900 queries, with 4 features sampled per query, with 48 images per set of images 402, and 64 embedding dimensions (e.g., 64 place feature vector). This may result in a matrix of 900×4×48×64, which may be flattened (e.g., aggregated by the adaptive mixing block 416) into a 900×12288 tensor. In some cases, the size of this tensor may make working with the tensor computationally difficult. Therefore, it may be useful to dynamically determine the number of samples to object, for example learned from previous layers, to more efficiently perform 3D object detection.

In some cases, it may be useful to enhance the technique for 3D object detection 400 by leveraging a state-space model architecture, such as mamba. In some cases, the state-space model architecture may be used in place of the spatio-temporal sampling block 414, adaptive mixing block 416, and add norm block 418.

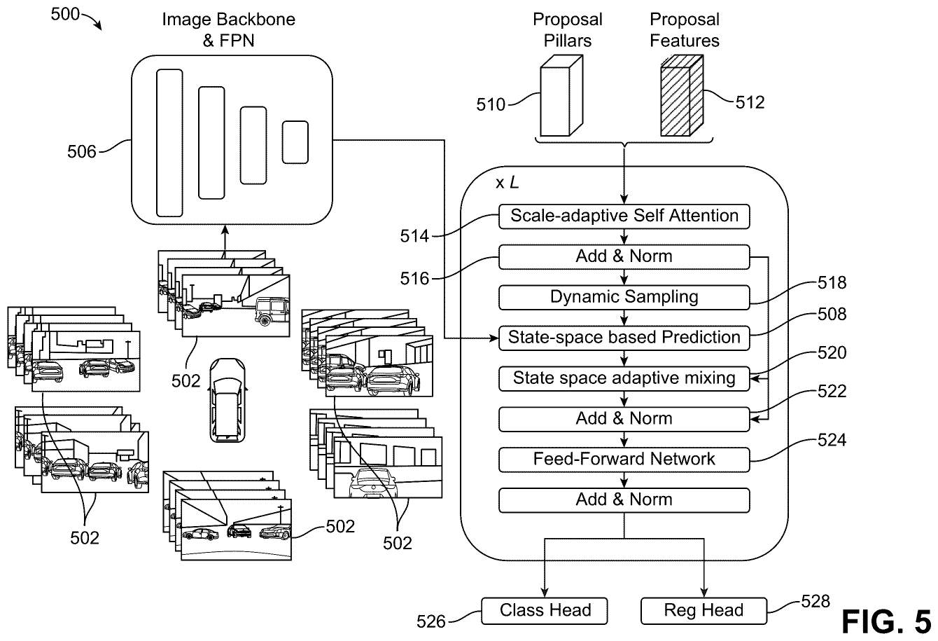

FIG. 5 is a block diagram illustrating an enhanced technique for 3D object detection 500 using state-space spatiotemporal learning and dynamic queries, in accordance with aspects of the present disclosure. Similar to the technique of FIG. 4, in the enhanced technique for 3D object detection 500, a set of images 502 may be captured and input to a feature extraction backbone 506 to detect and extract features from the set of images 502. The set of images 402 may include images from multiple cameras with different views taken at multiple points in time. The extracted features may be passed to a state-space based prediction block 508.

In some cases, a set of learnable query proposal pillars may be defined. A query proposal pillar 510 may represent a bounding box and the query proposal pillars 510 may be a vector that includes a 3D location (e.g., x, y, z coordinates), dimensions, rotation, and velocity in a BEV space. The query proposal pillar 510 may be associated with a D-dimensional query proposal feature 512 that may be used to encode features. In some cases, the features may be state-space model representation of features. The query proposal pillar 510 may be initially randomly placed within the BEV space. The query proposal pillar 510 may be input to a scale-adaptive self-attention block 514. The scale-adaptive self-attention block 514 may be similar to the scale-adaptive self-attention block 410 of FIG. 4 except that the scale-adaptive self-attention block 514 may perform self-attention on a state-space representation of features, which may be more efficient as compared to self-attention for a full representation of features. The scale-adaptive self-attention block 514 may output proposal features which are self-attended using adaptive scale factor which is further used in the dynamic sampling block 518.

The output of the scale-adaptive self-attention block 514 may be summed and normalized in an add norm block 516 and input to a dynamic sampling block 518. The dynamic sampling block 518, as discussed below, may adjust the queries via merging, reduction, and duplication to filter out unnecessary queries. Output from the dynamic sampling block 518 may be input to the state-space based prediction block 508. The state-space based prediction block 508, as discussed below, may learn state-space features of the scene (e.g., from the input features) and predict features (e.g., proposed features) for a next time step. The state-space features and predicted features may be input to a state-space adaptive mixing block 520.

The state-space adaptive mixing block 520 may perform mixing based on the state space features and the proposal features, as discussed below. The mixed features may be flattened, aggregated, and normalized by an add norm block 522. The flattened features may be passed to a feed-forward network 524, classification head 526, and regression head 528 to generate classification and regression predictions. In some cases, the classification head 526 and regression head 528 may be separate multi-layer perceptrons (MLPs). In some cases, the regression head 528 may perform a regression operation to identify features from the flattened features corresponding with objects in the environment and output bounding boxes based on pillars associated with those features corresponding with objects, and the classification head 526 may classify the objects in the bounding boxes for output.

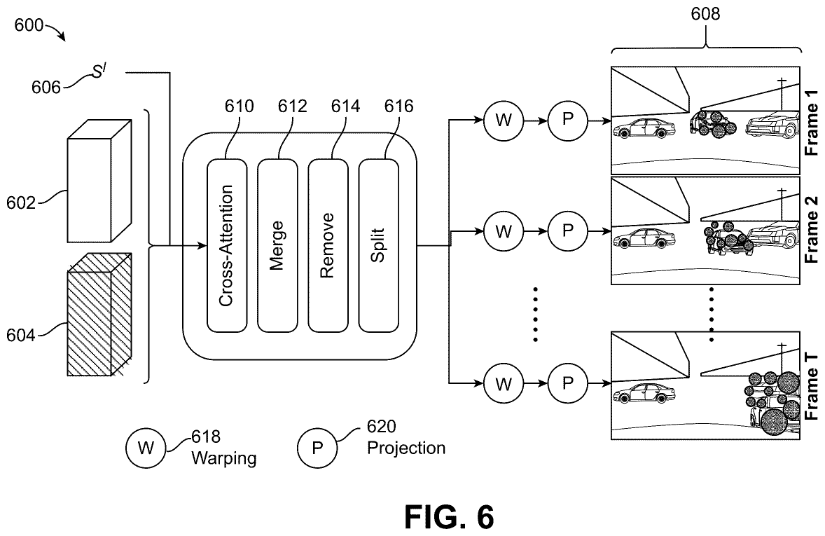

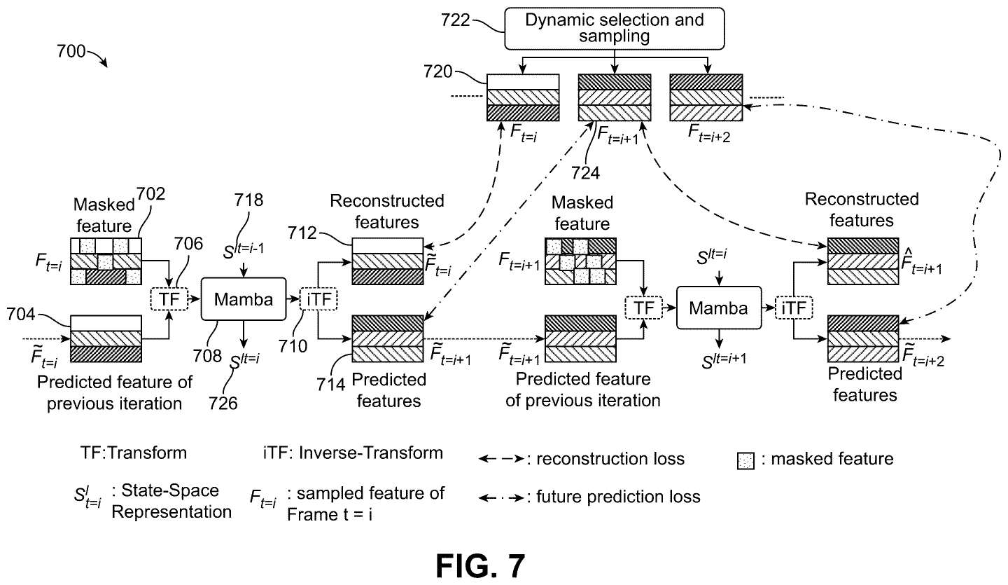

FIG. 6 is a block diagram illustration operations of a dynamic sampling block 600, in accordance with aspects of the present disclosure. In some cases, the dynamic sampling block 600 may be substantially similar to dynamic sampling block 518 of FIG. 5. The dynamic sampling block 600 may receive a set of proposal pillars 602 and associated proposal features 604, along with a previous state space features 606 S^{l} (e.g., previous state-space representation 718 of FIG. 7 generated for images captured prior to images being sampled 608). In some cases, the dynamic sampling block may perform a cross-attention 610 between the proposal features 604 and the previous state space features 606, followed by a merge operation 612, a remove operation 614, and a split operation 616 before sampling the image features.

In some cases, the cross-attention 610 may be a scale-adaptive self attention between the proposal features 604 and the previous state space features 606 that outputs a query proposal features (of dimension N_{q}×D, where N_{q} is number of queries in the current decoder layer). In some cases, N_{q} may be initialized at 900. The query proposal features may be passed to the merge operation 612.

The merge operation 612 may determine a covariance matrix (=C_{q}, with dimensions N_{q}×N_{q}) based on the query proposal features. This covariance matrix and the query proposal features may be passed through a linear layer to generate a merge label for each query and an index indicating which queries should be merged. The indicated queries may be merged. The merged query proposal features may be passed to the remove operation 614.

The remove operation 614 may use two linear layers to generate a remove label value for each query of the merged query proposal features indicating whether the query should be removed. Additionally, another linear layer may use the covariance matrix (C_{q}) and the merged query proposal features to generate a number indicating a percentage of queries to remove and a number of queries to split. The indicated queries may be removed and the remaining query proposal features passed to the split operation 616.

The split operation 616 may use two linear layers to generate a split label value indicating whether a query of the remaining query proposal feature should be split. The indicated queries of the remaining query proposal features may then be split to generate resulting query proposal features. The resulting query proposal features and their associated proposal pillars may be used to sample features from the images being sampled 608.

For sampling, a linear layer may be used to adaptively generate a set of sampling offsets {Δxᵢ,Δyᵢ,Δzᵢ} based on the resulting query proposal features cross attended with the previous state space features 606. These offsets may then be transformed into 3D sampling points based on the proposal pillars associated with the resulting query proposal features such that:

$$[ \begin{matrix}{x}_{i} \\ {y}_{i} \\ {z}_{i}\end{matrix} ] = [ \begin{matrix}cos θ & - s in θ & 0 \\ sin θ & cos θ & 0 \\ 0 & 0 & 1\end{matrix} ] [ \begin{matrix}w \cdot Δ {x}_{i} \\ l \cdot Δ {y}_{i} \\ h \cdot Δ {z}_{i}\end{matrix} ] + [ \begin{matrix}x \\ y \\ z\end{matrix} ] .$$

Features at points on the images being sampled 608 corresponding with the 3D sampling points from the proposal pillars may be sampled and placed in the associated resulting query proposal features.

Temporal alignment for the sampled points may be performed by warping 618 the sampled points based on motion of a vehicle as between times in which the images are taken. In some cases, the motion of the vehicle may be measured based on data from an inertial measurement unit (IMU) and/or data from one or more Global Navigation Satellite System (GNSS) receivers or transceivers. The IMU may be an electronic device that measures the specific force, angular rate, and/or the orientation of the vehicle, using a combination of one or more accelerometers, one or more gyroscopes, and/or one or more magnetometers. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. The warped points may be projected 620 onto each view using camera intrinsics and extrinsics.

FIG. 7 is a block diagram illustrating operations of a state-space based prediction engine 700, in accordance with aspects of the present disclosure. In some cases, the state-space based prediction engine 700 may be substantially similar to state-space based prediction block 508 of FIG. 5. In some cases, the state-space based prediction engine 700 may be used to learn a spatio-temporal state-space representation of the scene. Of note, the state-space based prediction engine 700 uses the Mamba state space model, but other state space models (e.g., recurrent neural networks, long short-term memory, etc.) may be used as well. In some cases, the state space mode may operate based on time steps of sets of images and the state space model may, for a time step i, generate reconstructed features for time step i and predicated features for a next time step i+1. In some cases, the internal states are updated inside the state space model and may be propagated through time steps.

In some cases, for each time step i for the input of a set of images (e.g., set of images 502 of FIG. 5), masked features 702 from time step i (Fₜ₌₁) and predicted features 704 (\tilde{F}ₜ₌₁) from a previous time step i−1 may be passed into a transform layer 706. In some cases, the masked features 702 may be obtained based on sampled features 720 from a dynamic sampling block 722 (e.g., dynamic sampling block 518 of FIG. 5, dynamic sampling block 600 of FIG. 6) and masked. In some cases, the features may be masked randomly. The predicted features 704 may be obtained from a previous iteration of the state-space prediction engine 700. The masked features 702 and predicted features 704 maybe concatenated to generate concatenated features and input to the transform layer 706. The transform layer 706 may perform a feature transform operation on the concatenated features, such as an identity transform, fast Fourier transform (FFT), discrete cosine transform, wavelet, etc., to generate transformed concatenated features. In some cases, the identity transform may be used when operating in a time domain and the FFT may be used when operating in the frequency domain. Different domains may be used to learn summary representations both spatially and temporally. The transformed concatenated features may be passed to a state space model 708 along with a previous state-space representation 718 (e.g., state space feature from the previous time step).

The state space model 708 may predict a current state-space representation 726, and a set of concatenated features. An inverse transform layer 710 may perform an inverse transform operation (e.g., inverse identity, inverse FFT, inverse cosine, etc.) to obtain a reconstructed features 712 of the masked features 702 and predicted features 714 for a next time step (i+1). The reconstructed features 712 may then be compared to the sampled features 720 and predicated features 704 to generate a supervised current feature loss ( [symbol] ᵣ) such that

$${ℒ}_{r} = i \frac{1}{T} {\sum }_{i = 1}^{T} {‖ {\hat{F}}_{t = i} - {\tilde{F}}_{t = i} ‖}^{2} .$$

Similarly, the predicated features 714 may be compared to sampled features at a next time step 724 to generate a supervised future feature loss ( [symbol] _{f}) such that

$${ℒ}_{f} = \frac{1}{T} {\sum }_{i = 1}^{T} {‖ {\tilde{F}}_{t = i + 1} - {F}_{t = i + 1} ‖}^{2} .$$

In some cases, the supervised current feature loss and supervised future feature loss may be applied in addition to other detection losses.

The supervised current feature loss and supervised future feature loss may be used to learn, for example, spatial orientations of different objects in the scene as well as temporal relations of the objects (e.g., via features collected over different times with multiple views of the object) to better predict the spatio-temporal state-space representation of the scene. In some cases, using masked features 702 and then predicting reconstructed features 712 forces the state space model to perform an auto encoding task to learn spatial relationships between features of the scene. Similarly, predicting reconstructed features forces the state space model to perform an auto encoding task to learn temporal relationships of the scene.

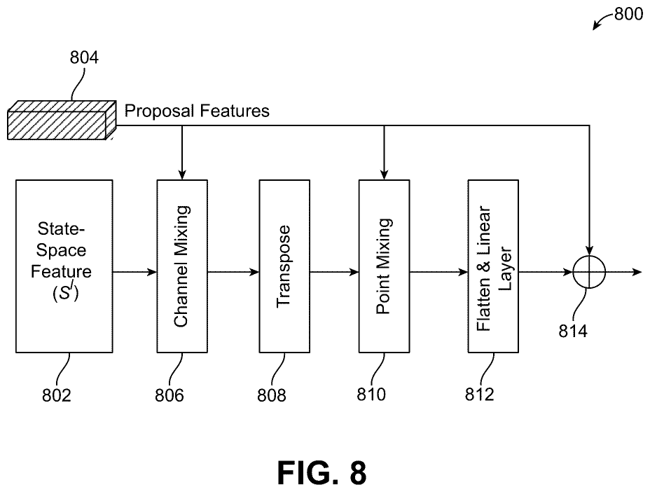

FIG. 8 is a block diagram illustrating operations of a state-space adaptive mixing block 800, in accordance with aspects of the present disclosure. In some cases, the state-space adaptive mixing block 800 may be substantially similar to state-space adaptive mixing block 520 of FIG. 5. In some cases, the state-space adaptive mixing block 800 may perform channel mixing and point mixing. For example, the state-space adaptive mixing block 800 may mix state space features 802 S^{l} (e.g., current state-space representation 726 of FIG. 7) with proposal features 804 (e.g., proposal features 512 of FIG. 5). In some cases, the proposal features 804 may be represented by a 3D matrix with a feature batchsize dimension, number of queries dimension, and a channel dimension. The state-space features 802 may be represented by a 4D matrix with a batchsize dimension, queries dimension, point dimension, and channel dimension. In some cases, the point dimension may indicate a number of points within a feature. For state-space features 802, the channel dimension may indicate image feature dimensions sampled. For proposal features 804, the channel dimension may indicate the instance feature of 3D objects in BEV space. As the state-space features 802 have a different number of dimensions as compared to the proposal features 804, channel mixing (e.g., attention in the channel direction) may be applied to adjust the dimensions of the proposal features 804 and then point mixing may be applied. Channel mixing may mix the channel dimensions of the proposal feature 804 and the state-space features 802. In some cases, the state space features 802 may be mixed using channel mixing by the channel mixing block 806 and a transpose operation 808 performed to obtain transposed mixed features. The transposed mixed features may be mixed with the proposal features 804 using point mixing by the point mixing block 810. In some cases, channel mixing (M_{c}) may be performed such that W_{c}=Linear(Q)∈ [symbol] ^{C×C} and

$${M}_{c} ( {S}_{t = T}^{l} ) = R e LU ( LayerNorm ( Transpose ( {S}_{t = T}^{l} ) {W}_{c} ) ) , \\ where {S}_{t = T}^{l} ∈ {ℝ}^{{N}_{q} \times P \times C} ,$$

N_{q} represents a number of queries, P represents a number of points, and C represents a channel dimension, S^{l} represents a state space feature, Q represents the proposal query feature, W_{c} is an intermediate output for performing attention in the channel dimension and is generated based on proposal query Q multiplied with state-space features S. The point mixing (Mₚ) may be performed such that Wₚ=Linear(Q)∈ [symbol] ^{P×P} and

$${M}_{p} ( {S}_{t = T}^{l} ) = ReLU ( LayerNorm ( Transpose ( {S}_{t = τ}^{l} ) {W}_{p} ) ) .$$

The resulting features from the point mixing block 810 may be flattened using a linear layer 812 and combined 814 with the proposal features 804 for output (e.g., output to the add norm block 522 of FIG. 5).

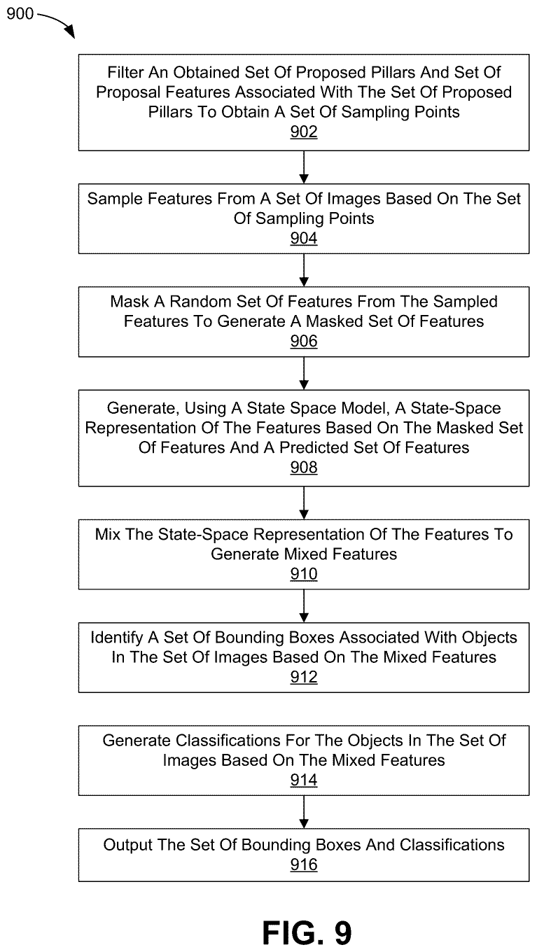

FIG. 9 is a flow diagram illustrating a process 900 for 3D object detection, in accordance with aspects of the present disclosure. The process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include coding device, such as an encoding device, decoding device, or a combined encoding device (or codec). The operations of the process 900 may be implemented as software components that are executed and run on one or more processors (such as CPU 102, GPU 104, DSP 106, NPU 108 of FIG. 1, processor 1010 of FIG. 10, etc.).

At block 902, the computing device (or component thereof) may filter an obtained set of proposal pillars (e.g., proposal pillar 510 of FIG. 5) and set of proposal features (e.g., proposal feature 512) associated with the set of proposal pillars to obtain a set of sampling points. For example, a dynamic sampling block, such as dynamic sampling block 518 of FIG. 5, dynamic sampling block 600 of FIG. 6, etc., may adjust the queries (e.g., the proposal pillars) via merging, reduction, and duplication to filter out unnecessary queries. In some cases, the set of proposal pillars is based on a filtered set of sampling points obtained based on previous set of images. In some examples, the computing device (or component thereof) may filter the obtained set of proposal pillars by performing cross-attention (e.g., cross-attention 610 of FIG. 6) between the set of proposal features and the state-space representation of the features to obtain a set of query proposal features; and performing at least one of a merge operation (e.g., merge operation 612 of FIG. 6), remove operation (e.g., remove operation 614 of FIG. 6), or split operation (e.g., split operation 616 of FIG. 6) on the set of query proposal features.

At block 904, the computing device (or component thereof) may sample features from a set of images (e.g., set of images 502 of FIG. 5, images being sampled 608 of FIG. 6) based on the set of sampling points. In some cases, the set of images comprises a number of images captured by a plurality of cameras.

At block 906, the computing device (or component thereof) may mask a random set of features from the sampled features to generate a masked set of features (e.g., masked features 702 of FIG. 7).

At block 908, the computing device (or component thereof) may generate, using a state space model (e.g., state space model 708 of FIG. 7), a state-space representation of the features (e.g., current state-space representation 726 of FIG. 7) based on the masked set of features and a predicted set of features (e.g., predicated features 704 of FIG. 7). In some cases, the computing device (or component thereof) may generate, using the state space model, the predicted set of features for a next set of images (e.g., predicted features 714 of FIG. 7). In some examples, the computing device (or component thereof) may generate, using the state space model, a set of reconstructed features (e.g., reconstructed features 712 of FIG. 7); determine a first loss value (e.g., current feature loss ( [symbol] ᵣ)) based on a difference between the set of reconstructed features and the sampled features; determine a second loss value (e.g., supervised future feature loss ( [symbol] _{f}) based on a difference between the predicted set of features and a set of sampled features based on the next set of images (e.g., sampled features at a next time step 724 of FIG. 7); and train the state space model based on the first loss value and the second loss value. In some cases, the computing device (or component thereof) may concatenate the masked set of features and the predicted set of features to generate concatenated features; and perform a feature transform on the concatenated features to generate transformed concatenated features, wherein the state-space representation is generated based on the transformed concatenated features. For example, masked features and predicted features maybe concatenated to generate concatenated features and input to the transform layer, and the transform layer may perform a feature transform operation on the concatenated features. In some cases, the feature transform comprises at least one of an identity transform, a fast Fourier transform (FFT), a discrete cosine transform, or a wavelet transform.

At block 910, the computing device (or component thereof) may mix the state-space representation of the features to generate mixed features. For example, a state-space adaptive mixing block (e.g., state-space adaptive mixing block 520 of FIG. 5, state-space adaptive mixing block 800 of FIG. 8) may perform mixing based on the state space features (e.g., state space features 802 of FIG. 8) and the proposal features (e.g., proposal features 804 of FIG. 8). In some cases, mixing the state-space representation of the features comprises channel mixing (e.g., channel mixing 806 of FIG. 8) and point mixing (e.g., point mixing 810 of FIG. 8).

At block 912, the computing device (or component thereof) may identify a set of bounding boxes associated with objects in the set of images based on the mixed features.

At block 914, the computing device (or component thereof) may generate classifications for the objects in the set of images based on the mixed features. For example, the regression head (e.g., regression head 528 of FIG. 5) may perform a regression operation to identify features from the flattened features corresponding with objects in the environment and output bounding boxes based on pillars associated with those features corresponding with objects, and the classification head (e.g., classification head 526 of FIG. 5) may classify the objects in the bounding boxes for output.

At block 916, the computing device (or component thereof) may output the set of bounding boxes and classifications.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900 and/or other processes described herein may include a processor, microprocessor, micro-computer, or other component of a device that is configured to carry out the steps of the process 900 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 illustrates an example computing device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1000 are shown in electrical communication with each other using connection 1005, such as a bus. The example computing device architecture 1000 includes a processing unit (CPU or processor) 1010 and computing device connection 1005 that couples various computing device components including computing device memory 1015, such as read only memory (ROM) 1020 and random access memory (RAM) 1025, to processor 1010.

Computing device architecture 1000 can include a cache of high-speed memory connected directly with, in close proximity to, or integrated as part of processor 1010. Computing device architecture 1000 can copy data from memory 1015 and/or the storage device 1030 to cache 1012 for quick access by processor 1010. In this way, the cache can provide a performance boost that avoids processor 1010 delays while waiting for data. These and other modules can control or be configured to control processor 1010 to perform various actions. Other computing device memory 1015 may be available for use as well. Memory 1015 can include multiple different types of memory with different performance characteristics. Processor 1010 can include any general purpose processor and a hardware or software service, such as service 1 1032, service 2 1034, and service 3 1036 stored in storage device 1030, configured to control processor 1010 as well as a special-purpose processor where software instructions are incorporated into the processor design. Processor 1010 may be a self-contained system, containing multiple cores or processors, a bus, memory controller, cache, etc. A multi-core processor may be symmetric or asymmetric.

To enable user interaction with the computing device architecture 1000, input device 1045 can represent any number of input mechanisms, such as a microphone for speech, a touch-sensitive screen for gesture or graphical input, keyboard, mouse, motion input, speech and so forth. Output device 1035 can also be one or more of a number of output mechanisms known to those of skill in the art, such as a display, projector, television, speaker device, etc. In some instances, multimodal computing devices can enable a user to provide multiple types of input to communicate with computing device architecture 1000. Communication interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. Storage device 1030 can include services 1032, 1034, 1036 for controlling processor 1010. Other hardware or software modules are contemplated. Storage device 1030 can be connected to the computing device connection 1005. In one aspect, a hardware module that performs a particular function can include the software component stored in a computer-readable medium in connection with the necessary hardware components, such as processor 1010, connection 1005, output device 1035, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for 3D object detection, comprising: at least one memory; and at least one processor coupled to the at least one memory, the at least one processor being configured to: filter an obtained set of proposal pillars and set of proposal features associated with the set of proposal pillars to obtain a set of sampling points; sample features from a set of images based on the set of sampling points; mask a random set of features from the sampled features to generate a masked set of features; generate, using a state space model, a state-space representation of the features based on the masked set of features and a predicted set of features; mix the state-space representation of the features to generate mixed features; identify a set of bounding boxes associated with objects in the set of images based on the mixed features; generate classifications for the objects in the set of images based on the mixed features; and output the set of bounding boxes and classifications.

Aspect 2. The apparatus of Aspect 1, wherein the set of proposal pillars is based on a filtered set of sampling points obtained based on previous set of images.

Aspect 3. The apparatus of any of Aspects 1-2, wherein, to filter the obtained set of proposal pillars, the at least one processor is configured to: perform cross-attention between the set of proposal features and the state-space representation of the features to obtain a set of query proposal features; and perform at least one of a merge operation, remove operation, or split operation on the set of query proposal features.

Aspect 4. The apparatus of any of Aspects 1-3, wherein the at least one processor is configured to generate, using the state space model, the predicted set of features for a next set of images.

Aspect 5. The apparatus of Aspect 4, wherein the at least one processor is configured to: generate, using the state space model, a set of reconstructed features; determine a first loss value based on a difference between the set of reconstructed features and the sampled features; determine a second loss value based on a difference between the predicted set of features and a set of sampled features based on the next set of images; and train the state space model based on the first loss value and the second loss value.

Aspect 6. The apparatus of any of Aspects 1-5, wherein the at least one processor is configured to: concatenate the masked set of features and the predicted set of features to generate concatenated features; and perform a feature transform on the concatenated features to generate transformed concatenated features, wherein the state-space representation is generated based on the transformed concatenated features.

Aspect 7. The apparatus of Aspect 6, wherein the feature transform comprises at least one of an identity transform, a fast Fourier transform (FFT), a discrete cosine transform, or a wavelet transform.

Aspect 8. The apparatus of any of Aspects 1-7, wherein mixing the state-space representation of the features comprises channel mixing and point mixing.

Aspect 9. The apparatus of any of Aspects 1-8, wherein the set of images comprises a number of images captured by a plurality of cameras.

Aspect 10. The apparatus of any of Aspects 1-9, wherein the at least one processor is configured to detect features from the set of images.

Aspect 11. The apparatus of any of Aspects 1-10, wherein the apparatus further comprises one or more cameras for capturing the set of images.

Aspect 12. A method for 3D object detection, comprising: filtering an obtained set of proposal pillars and set of proposal features associated with the set of proposal pillars to obtain a set of sampling points; sampling features from a set of images based on the set of sampling points; masking a random set of features from the sampled features to generate a masked set of features; generating, using a state space model, a state-space representation of the features based on the masked set of features and a predicted set of features; mixing the state-space representation of the features to generate mixed features; identifying a set of bounding boxes associated with objects in the set of images based on the mixed features; generating classifications for the objects in the set of images based on the mixed features; and outputting the set of bounding boxes and classifications.

Aspect 13. The method of Aspect 12, wherein the set of proposal pillars is based on a filtered set of sampling points obtained based on previous set of images.

Aspect 14. The method of any of Aspects 12-13, wherein filtering the obtained set of proposal pillars comprises: performing cross-attention between the set of proposal features and the state-space representation of the features to obtain a set of query proposal features; and performing at least one of a merge operation, remove operation, or split operation on the set of query proposal features.

Aspect 15. The method of any of Aspects 12-14, further comprising generating, using the state space model, the predicted set of features for a next set of images.

Aspect 16. The method of Aspect 15, further comprising: generating, using the state space model, a set of reconstructed features; determining a first loss value based on a difference between the set of reconstructed features and the sampled features; determining a second loss value based on a difference between the predicted set of features and a set of sampled features based on the next set of images; and training the state space model based on the first loss value and the second loss value.

Aspect 17. The method of any of Aspects 12-16, further comprising: concatenating the masked set of features and the predicted set of features to generate concatenated features; and performing a feature transform on the concatenated features to generate transformed concatenated features, wherein the state-space representation is generated based on the transformed concatenated features.

Aspect 18. The method of Aspect 17, wherein the feature transform comprises at least one of an identity transform, a fast Fourier transform (FFT), a discrete cosine transform, or a wavelet transform.

Aspect 19. The method of any of Aspects 12-18, wherein mixing the state-space representation of the features comprises channel mixing and point mixing.

Aspect 20. The method of any of Aspects 12-19, wherein the set of images comprises a number of images captured by a plurality of cameras.

Aspect 21. The method of any of Aspects 12-20, further comprising detecting features from the set of images.

Aspect 22: An apparatus for 3D object detection, comprising one or more means for performing any of the operations of Aspects 12 to 21.

Aspect 23. A non-transitory computer-readable medium having stored thereon instructions that, when executed by at least one processor, cause the at least one processor to perform any of the operations of Aspects 12-21.

What is claimed is:

1. An apparatus for 3D object detection, comprising:
one or more memories; and
one or more processors coupled to the one or more memories, the one or more processors being configured to:
filter an obtained set of proposal pillars and set of proposal features associated with the set of proposal pillars to obtain a set of sampling points;
sample features from a set of images based on the set of sampling points;
mask a random set of features from the sampled features to generate a masked set of features;
generate, using a state space model, a state-space representation of the features based on the masked set of features and a predicted set of features;
mix the state-space representation of the features to generate mixed features;
identify a set of bounding boxes associated with objects in the set of images based on the mixed features;
generate classifications for the objects in the set of images based on the mixed features; and
output the set of bounding boxes and classifications.

2. The apparatus of claim 1, wherein the set of proposal pillars is based on a filtered set of sampling points obtained based on previous set of images.

3. The apparatus of claim 1, wherein, to filter the obtained set of proposal pillars, the one or more processors are configured to:
perform cross-attention between the set of proposal features and the state-space representation of the features to obtain a set of query proposal features; and
perform at least one of a merge operation, remove operation, or split operation on the set of query proposal features.

4. The apparatus of claim 1, wherein the one or more processors are configured to generate, using the state space model, the predicted set of features for a next set of images.

5. The apparatus of claim 4, wherein the one or more processors are configured to:
generate, using the state space model, a set of reconstructed features;
determine a first loss value based on a difference between the set of reconstructed features and the sampled features;
determine a second loss value based on a difference between the predicted set of features and a set of sampled features based on the next set of images; and
train the state space model based on the first loss value and the second loss value.

6. The apparatus of claim 1, wherein the one or more processors are configured to:
concatenate the masked set of features and the predicted set of features to generate concatenated features; and
perform a feature transform on the concatenated features to generate transformed concatenated features, wherein the state-space representation is generated based on the transformed concatenated features.

7. The apparatus of claim 6, wherein the feature transform comprises at least one of an identity transform, a fast Fourier transform (FFT), a discrete cosine transform, or a wavelet transform.

8. The apparatus of claim 1, wherein mixing the state-space representation of the features comprises channel mixing and point mixing.

9. The apparatus of claim 1, wherein the set of images comprises a number of images captured by a plurality of cameras.

10. The apparatus of claim 1, wherein the one or more processors are configured to detect features from the set of images.

11. The apparatus of claim 1, further comprising one or more cameras for capturing the set of images.

12. A method for 3D object detection, comprising:
filtering an obtained set of proposal pillars and set of proposal features associated with the set of proposal pillars to obtain a set of sampling points;
sampling features from a set of images based on the set of sampling points;
masking a random set of features from the sampled features to generate a masked set of features;
generating, using a state space model, a state-space representation of the features based on the masked set of features and a predicted set of features;
mixing the state-space representation of the features to generate mixed features;
identifying a set of bounding boxes associated with objects in the set of images based on the mixed features;
generating classifications for the objects in the set of images based on the mixed features; and
outputting the set of bounding boxes and classifications.

13. The method of claim 12, wherein the set of proposal pillars is based on a filtered set of sampling points obtained based on previous set of images.

14. The method of claim 12, wherein filtering the obtained set of proposal pillars comprises:
performing cross-attention between the set of proposal features and the state-space representation of the features to obtain a set of query proposal features; and
performing at least one of a merge operation, remove operation, or split operation on the set of query proposal features.

15. The method of claim 12, further comprising generating, using the state space model, the predicted set of features for a next set of images.

16. The method of claim 15, further comprising:
generating, using the state space model, a set of reconstructed features;
determining a first loss value based on a difference between the set of reconstructed features and the sampled features;
determining a second loss value based on a difference between the predicted set of features and a set of sampled features based on the next set of images; and
training the state space model based on the first loss value and the second loss value.

17. The method of claim 12, further comprising:
concatenating the masked set of features and the predicted set of features to generate concatenated features; and
performing a feature transform on the concatenated features to generate transformed concatenated features, wherein the state-space representation is generated based on the transformed concatenated features.

18. The method of claim 17, wherein the feature transform comprises at least one of an identity transform, a fast Fourier transform (FFT), a discrete cosine transform, or a wavelet transform.

19. The method of claim 12, wherein mixing the state-space representation of the features comprises channel mixing and point mixing.

20. The method of claim 12, wherein the set of images comprises a number of images captured by a plurality of cameras.
